(19) United States
(12) Patent Application Publication
(10) Pub. No.: US 2016/0078153 A1
(43) Pub. Date: Mar. 17, 2016

(54) SUBTHRESHOLD STANDARD CELL LOGIC LIBRARY

(71) Applicants: Nackieb M. Kamin, Kapolei, HI (US); Gregory Lum, Honoluly, HI (US); Henry Au, Honolulu, HI (US)

(72) Inventors: Nackieb M. Kamin, Kapolei, HI (US); Gregory Lum, Honoluly, HI (US); Henry Au, Honolulu, HI (US)

(21) Appl. No.: 13/564,902

(22) Filed: Aug. 2, 2012

(51) Int. Cl. G06F 17/50

(52) U.S. Cl. CPC G06F 17/505

(57) ABSTRACT

A subthreshold standard cell library addresses the energy efficiency of electronic systems, thereby significantly reducing power consumption. Recent energy performance requirements are causing the next-generation system manufacturers to explore approaches to lower power consumption. Subthreshold operation has been examined and implemented in designing ultra low power standard cell designs that operate beyond the normal modes of operation, with the potential for large energy savings. Operation of CMOS (Complementary Metal Oxide Semiconductor) transistors in the subthreshold regime, where the supply voltage used in operation is orders of magnitude below the normal operating voltage of typical transistors, has proven to be very beneficial for energy constrained systems as it enables minimum energy consumption in Application Specific Integrated Circuits (ASICs).

### FEDERALLY-SPONSORED RESEARCH AND DEVELOPMENT

This invention (Navy Case NC 101,400) is assigned to the United States Government and is available for licensing for commercial purposes. Licensing and technical inquiries may be directed to the Office of Research and Technical Applications, Space and Naval Warfare Systems Center, Pacific, Code 72120, San Diego, Calif., 92152; voice (619) 553-2778; email T2@spawar.navy.mil.

### BACKGROUND OF THE INVENTION

This invention addresses the energy efficiency of electronic systems, thereby significantly reducing power consumption. This invention addresses in particular application specific integrated circuit (ASIC) devices.

Previous methods of increasing battery life for an ASIC device meant increasing the capacity of the battery. This is done by either improving the battery technology or increasing the size of the battery. However, by operating the ASIC device in the subthreshold region of operation the power reduction can be orders of magnitude less. This negates the need for a larger, heavier and more costly battery.

### SUMMARY OF THE INVENTION

In one embodiment, the standard cell logic library comprises a logic gates component for synthesizing application specific integrated circuits each operating in the subthreshold voltage region; an operating Vdd component including positive supply voltages for the respective integrated circuits; a synthesis library component including timing, temperature and physical characteristics of the respective integrated circuits; and

a physical library component including symbol, schematic and mask layouts for the respective circuits.

### BRIEF DESCRIPTION OF THE DRAWINGS

The invention will be more fully described in connection with the annexed drawings, where like reference characters designate like components, in which:

FIG. 1 shows a block diagram of a subthreshold standard cell library.

FIG. 2 shows symbol diagrams for the logic devices in the library of FIG. 1.

FIGS. 3A and 3B show current-voltage characteristics of an N-type MOSFET device.

### DETAILED DESCRIPTION OF THE EMBODIMENTS

One purpose of this invention is to provide a subthreshold standard cell logic library for designing application specific integrated circuits for sensor systems. In particular, an ultra low power Complementary Metal Oxide Semiconductor (CMOS) standard cell library of logic devices is provided for operating in the subthreshold region for synthesizing Application Specific Integrated Circuits (ASICs).

This invention addresses the energy efficiency of electronic systems, thereby significantly reducing power consumption. Recent energy performance requirements are causing the next-generation system manufacturers to explore approaches to lower power consumption. Subthreshold operation has been examined and implemented in designing ultra low power standard cell designs that operate beyond the normal modes of operation, with the potential for large energy savings.

Operation of CMOS (Complementary Metal Oxide Semiconductor) transistors in the subthreshold regime, where the supply voltage used in operation is orders of magnitude below the normal operating voltage of typical transistors, has proven to be very beneficial for energy constrained systems as it enables minimum energy consumption in Application Specific Integrated Circuits (ASICs).

Each standard cell consists of a combination of Metal Oxide Semiconductor Field Effect Transistors (MOSFETs). In MOSFETs a voltage on the oxide-insulated gate electrode can induce a conducting channel between the two other contacts called source and drain and an inversion layer forms at the interface between the oxide and the body of the transistor.

MOSFETs typically operate in three regions of operation—strong, moderate, and weak inversion (or subthreshold). Most advanced devices typically operate in strong or moderate inversion region; therefore, many foundries only develop logic standard cells for ASIC/System-on-Chip (SoC) designs for the strong and moderate region of operation.

A subthreshold standard cell library is provided for replacing ASICs and SoCs with one that uses a fraction of the same amount of power. The subthreshold ASIC is able to have the exact same functionally as the original. An important resulting difference is the improved performance that follows the decrease in power consumption.

As described above, previous methods of increasing battery life meant increasing the capacity of the battery. This is done by either improving the battery technology or increasing the size of the battery. However, by operating the ASIC device in the subthreshold region of operation the power reduction can be orders of magnitude less. This negates the need for a larger, heavier and more costly battery.

This invention is a standard cell library operating in the subthreshold region of operation. By operating in this ultra low power region the transistors use a fraction of the power they normally would.

Currently Application Specific Integrated Circuits (ASICs) can consist of upwards of millions of transistors. By reducing the power for each of the transistors the total circuit would consume orders of magnitude less power. The power is reduced by the smaller applied electric field applied to the transistors. This generic 0.25 μm technology subthreshold standard cell library for System-on-Chip (SoC) solutions comprises: the logic gates, operating V_{dd} (positive supply voltage), synthesis library, and a physical library.

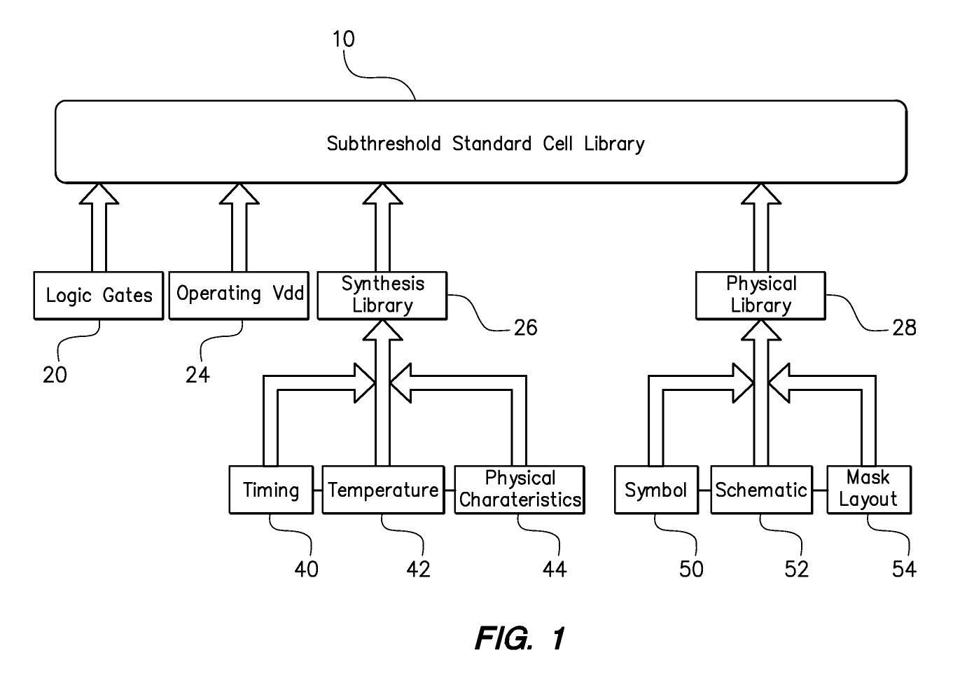

FIG. 1 is a block diagram of the components of the subthreshold standard cell library 10. FIG. 1 also depicts the correlation of the different components of the standard cell library 10.

The components shown in FIG. 1 include logic gates component 20, operating Vdd component 24, synthesis library component 26, and physical library component 28.

The synthesis library 26 includes timing component 40, temperature component 42, and physical characteristics component 44. The physical library 28 includes symbol component 50, schematic component 52, and mask layout 54.

The ultra low power logic gates 20 in FIG. 1 are made up of different combinations and quantities of MOSFET (Metal Oxide Semiconductor Field Effect Transistor) devices to create the corresponding Boolean function. These logic gates 20 are used to synthesize Application Specific Integrated Circuits (ASICs) operating in the subthreshold regime or weak inversion region. This results in much lower power consumption due to a lower applied electric field.

The operating Vdd component 24 represents the positive operating supply voltage inputs.

The synthesis library 26 contains the timing 40, temperature 42, and physical characteristics 44. The physical makeup describes the properties of the materials, fabrication, etc. A corresponding physical library 28 for each component (library cell), comprising a symbol 50, schematic 52, and mask layout 54 is also included.

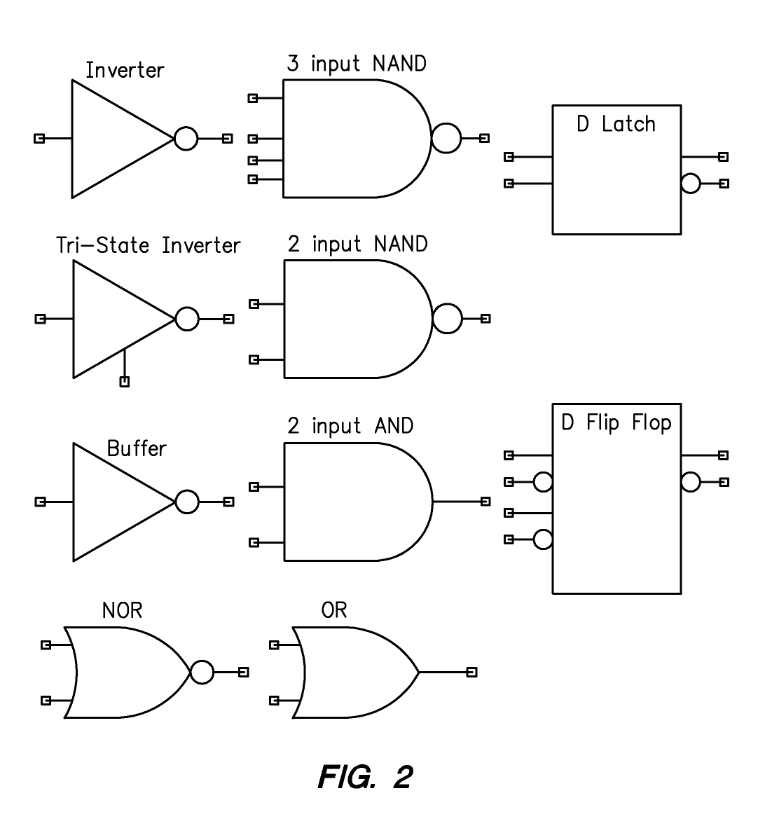

FIG. 2 is the symbol diagram for each of the ten logic devices in the subthreshold standard cell library. The subthreshold voltage is characterized by being 10-20% of the nominal bias voltage.

In FIG. 2, the logic gates included in the subthreshold standard cell library are: inverter, tri-state inverter, 3 input NAND, 2 input NAND, 2 input AND, 2 input NOR, 2 input OR, buffer, D latch, and a D flip flop.

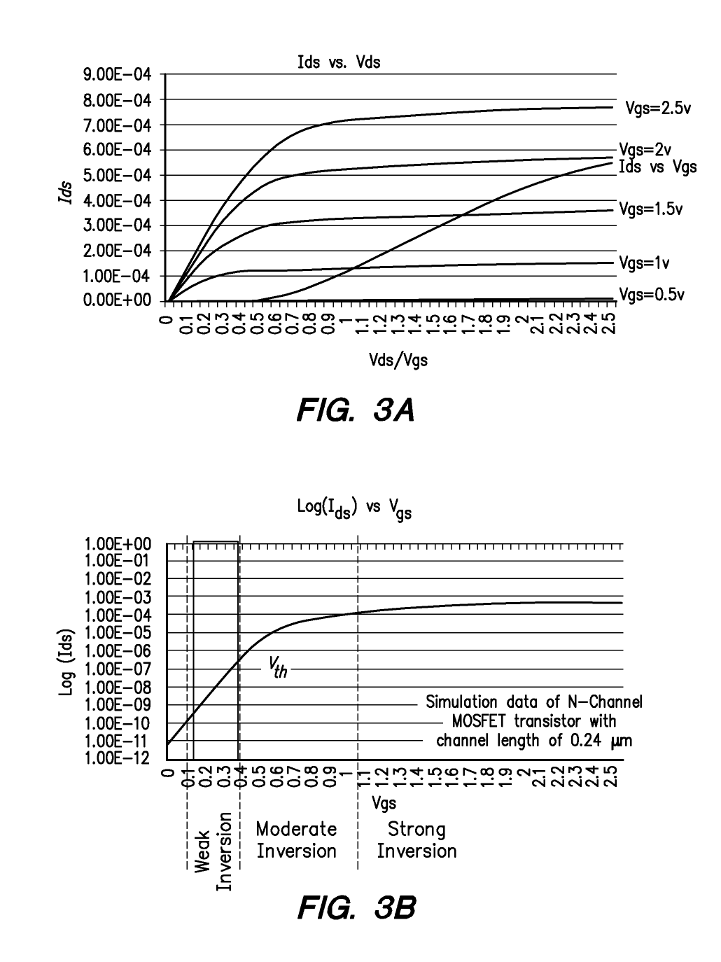

FIG. 3A shows current-voltage characteristics of an N-type MOSFET device, with parameters Ids vs. Vds.

FIG. 3B illustrates strong, moderate, and weak inversion regions of operation. The weak inversion region, also known as subthreshold region, is highlighted in grayscale. The parameters in FIG. 3B are Log (Ids) vs. Vgs.

Note the lower levels of Ids when Vgs is in the weak or subthreshold inverion region shown in FIG. 3B.

The advantages and novel aspects of this invention over the current methods is a reduction in power consumption (orders of magnitude), reduced heat generation, increased longevity of the circuit and smaller required power supply. With reduced heat generation there can also be less required cooling for the ASIC. Normally at the transistor level they are operated in the strong inversion region as their region of operation. The difference in this invention is that the devices described in the standard cell library operate in the subthreshold region which is within the weak inversion region.

The library can be used with other fabrication process technologies in design of ASICs. One embodiment is designed on the TSMC 0.25 μm process, but it can be applied to other processes, such as IBM and other TSMC feature sizes. The subthreshold standard cell library can be applied to any ASIC that needs improved battery life over outright performance.

While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

1. A standard cell logic library for synthesizing an application specific integrated circuit (ASIC) using a TSMC 0.25 μm process, said library comprising:
a plurality of logic gates component each of said components operating in the subthreshold voltage region;
an operating V_{dd} component including positive supply voltages in the subthreshold voltage region for said ASIC;
a synthesis library input component including timing, temperature and physical characteristics for said ASIC; and
a physical library component including symbol, schematic and mask layouts for said ASIC.

2. (canceled)

3. The logic library of claim 1 wherein the subthreshold region includes a subthreshold voltage characterized by approximately 10-20% of nominal bias voltage.

4. The logic library of claim 3 wherein the logic gates include one or more of the group of inverter, tri-state inverter, 3 input NAND, 2 input NAND, 2 input AND, 2 input NOR, 2 input OR, buffer, D latch, and a D flip flop logic gates.

5. (canceled)

6. (canceled)

7. (canceled)

8. (canceled)

9. (canceled)

10. (canceled)

11. (canceled)
